(19) United States
(12) Patent Application Publication
(10) Pub. No.: US 2011/0116414 A1
(43) Pub. Date: May 19, 2011

(54) APPARATUS AND METHOD FOR COMMUNICATION IN WIRELESS SENSOR NETWORK

(76) Inventors: Eun-Ju Lee, Daejeon-city (KR); Jae-Hong Ryu, Daejeon-city (KR); Byeong-Cheol Choi, Daejeon-city (KR); Bong-Wan Kim, Daejeon-city (KR); Bong-Soo Kim, Daejeon-city (KR); Cheol-Sig Pyo, Daejeon-city (KR); Jong-Suk Chae, Daejeon-city (KR)

(21) Appl. No.: 12/808,509

(22) PCT Filed: Mar. 18, 2008
(86) PCT No.: PCT/KR2008/001508

§ 371 Date: Jun. 16, 2010

(30) Foreign Application Priority Data
Dec. 17, 2007 (KR) 10-2007-0132704

(51) Int. Cl. H04W 4/00; H04L 12/28

(52) U.S. Cl. 370/254; 370/328

(57) ABSTRACT

Provided are a bridge system, a network management server, and communication methods at the bridge system and the network management server for efficient communication in a wireless sensor network (WSN). The communication method at the network management server includes communicating with bridge systems connected with a plurality of radio frequency (RF) regions within a personal area network (PAN) composed of sensor nodes using the same wireless channel, in which radio signals of the sensor nodes within the PAN reach the bridge systems, searching for a new channel to be used and an alternative bridge system which is to perform a channel change into the new channel based on information about the bridge systems upon receipt of an association failure report message from an error bridge system which is reported of an association failure from the RF region from among the bridge systems, sending a channel change request message to the found alternative bridge system, and adjusting channel information for the found alternative bridge system to the new channel and replacing information about sensor nodes connected to the found alternative bridge system with information about sensor nodes that are newly connected with the found alternative bridge system through the new channel.

### CROSS-REFERENCE TO RELATED PATENT APPLICATION

This application claims the benefit of Korean Patent Application No. 10-2007-0132704, filed on Dec. 17, 2007, in the Korean Intellectual Property Office, the disclosure of which is incorporated herein in its entirety by reference.

### BACKGROUND OF THE INVENTION

1. Field of the Invention

The present invention generally relates to an apparatus and method for communication in a wireless sensor network (WSN), and more particularly, to a method of configuring a WSN by using a bridge system in order to improve network stability and capacity.

This work was supported by the IT R&D program of MIC/IITA [2005-S-038-03, Development of UHF RF-ID and Ubiquitous Networking Technology].

2. Description of the Related Art

Wireless sensor network (WSN) technology is used to form an autonomous network by scattering sensor nodes having computing and wireless communication capabilities to a natural environment or an electric field and transmit and receive sensed information obtained through a wireless network between the sensor nodes, thereby allowing monitoring and controlling through the network at a remote site. A WSN, which is the core basis of a ubiquitous network, has been used in various application fields such as environmental monitoring, medical systems, telemetics, home networks, and logistics systems. The standard IEEE 802.15.4 applied to a wireless sensor network is suitable for implementing WSNs in various application fields due to its low complexity, low price, low power-consumption, and low data transfer rate.

FIG. 1 illustrates the structure of a conventional WSN.

Referring to FIG. 1, the conventional WSN includes a sensor node 110, a gateway 120, and a network management server 130.

The sensor node 110 is a sensor, processor and communication device which delivers or computes information sensed in environmental and physical systems or particular sensor-related events based on a wireless communication technique. The sensor node 110 collects and communicates the sensed information on a ZigBee basis.

The gateway 120 serves as a sink node, collects the sensed information obtained by the sensor node 110 or links event data with outside the WSN, manages a related sensor network, and links an internet protocol (IP)-based network with the WSN in order to provide a ubiquitous sensor network (USN) service through various IP-based access networks such as local area networks (LANs), wireless LANs (WLANs), code division multiple access (CDMA) networks, wireless broadband (WiBro) networks, and satellite networks. The gateway 120 is also connected with the network management server 130 in order to report configuration information of the WSN and sensed information and receives information required for configuring the WSN from the network management server 130 in order to configure the WSN.

The network management server 130 performs configuration management and fault management of the WSN and collects and manages the sensed information, thereby performing overall control and management of the WSN.

### SUMMARY OF THE INVENTION

The present invention provides an apparatus and method for communication in a wireless sensor network (WSN), whereby the WSN is configured by using different channels for different bridge systems in the same personal area network (PAN) and the same space in order to achieve the same effect as that of a system using multi-channels and improve the stability and capacity of the WSN.

According to an aspect of the present invention, there is provided a network management server of a wireless sensor network (WSN). The network management server includes a communication unit communicating with bridge systems connected with a plurality of radio frequency (RF) regions within a personal area network (PAN) composed of sensor nodes using the same wireless channel, in which radio signals of the sensor nodes within the PAN reach the bridge systems, a search unit searching for a new channel to be used and an alternative bridge system which is to perform a channel change into the new channel based on information about the bridge systems upon receipt of an association failure report message from an error bridge system which is reported of an association failure from the RF region from among the bridge systems, a channel change requesting unit sending a channel change request message to the found alternative bridge system, and an information management unit adjusting channel information for the found alternative bridge system to the new channel and replacing information about sensor nodes connected to the found alternative bridge system with information about sensor nodes that are newly connected with the found alternative bridge system through the new channel.

According to another aspect of the present invention, there is provided a bridge system of a wireless sensor network (WSN). The bridge system includes a communication unit communicating with a radio frequency (RF) region within a personal area network (PAN) composed of sensor nodes using the same wireless channel, by using a particular channel and an information management unit, upon receipt of a message requesting a change into a channel that is different form the particular channel from a network management server, registering information about the different channel and replacing information about sensor nodes connected through the particular channel with information about sensor nodes connected through the different channel, in which the communication unit communicates with the sensor nodes connected through the different channel by using the different channel if the information about the different channel is registered.

According to another aspect of the present invention, there is provided a communication method at a network management server of a wireless sensor network (WSN). The communication method includes communicating with bridge systems connected with a plurality of radio frequency (RF) regions within a personal area network (PAN) composed of sensor nodes using the same wireless channel, in which radio signals of the sensor nodes within the PAN reach the bridge systems, searching for a new channel to be used and an alternative bridge system which is to perform a channel change into the new channel based on information about the bridge systems upon receipt of an association failure report message from an error bridge system which is reported of an association failure from the RF region from among the bridge systems, sending a channel change request message to the found alternative bridge system, and adjusting channel information for the found alternative bridge system to the new channel and replacing information about sensor nodes connected to the found alternative bridge system with information about sensor nodes that are newly connected with the found alternative bridge system through the new channel.

According to another aspect of the present invention, there is provided a communication method at a bridge system of a wireless sensor network (WSN). The communication method includes communicating with a radio frequency (RF) region within a personal area network (PAN) composed of sensor nodes using the same wireless channel, by using a particular channel and upon receiving a message requesting a change into a channel that is different form the particular channel from a network management server, registering information about the different channel and replacing information about sensor nodes connected through the particular channel with information about sensor nodes connected through the different channel, in which the communication comprises communicating with the sensor nodes connected through the different channel by using the different channel if the information about the different channel is registered.

### BRIEF DESCRIPTION OF THE DRAWINGS

The above and other features and advantages of the present invention will become more apparent by describing in detail an embodiment thereof with reference to the attached drawings in which:

FIG. 1 illustrates the structure of a conventional wireless sensor network (WSN);

FIG. 2 illustrates the structure of a WSN according to an embodiment of the present invention;

FIG. 3 is a ladder diagram illustrating a process of initializing a gateway according to an embodiment of the present invention;

FIG. 4 is a ladder diagram illustrating a process of initializing a bridge system according to an embodiment of the present invention;

FIG. 5 is a ladder diagram illustrating a process of connecting a sensor node to a WSN according to an embodiment of the present invention;

FIG. 6 is a ladder diagram illustrating a process of reporting an association failure according to an embodiment of the present invention; and

FIG. 7 is a ladder diagram illustrating a process of requesting a wireless channel change according to an embodiment of the present invention.

### DETAILED DESCRIPTION OF THE INVENTION

Hereinafter, an embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

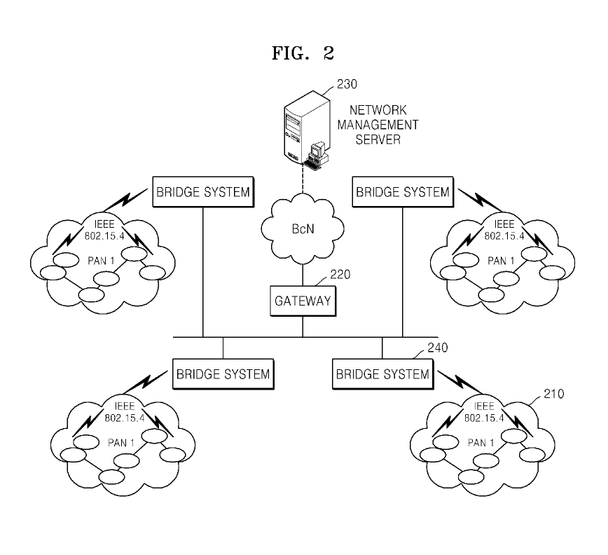

FIG. 2 illustrates the structure of a wireless sensor network (WSN) according to an embodiment of the present invention.

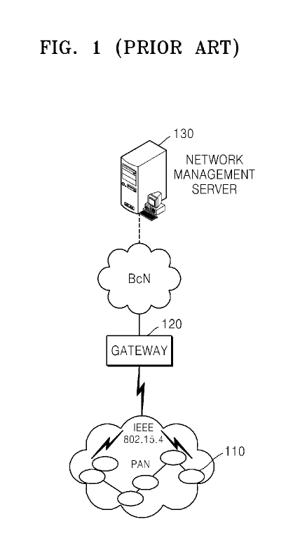

Referring to FIG. 2, the WSN according to an embodiment of the present invention includes sensor nodes 210, bridge systems 240, a gateway 220, and a network management server 230. The sensor node 210 and the gateway 220 basically function in the same manner as in FIG. 1.

The bridge system 240 is a system for connection between WSNs by using an internet protocol (IP) network and a wireless network. On a currently configured network, the bridge systems 240 communicate with each other by using the IP network and communicate with the sensor nodes 210 in a wireless manner. The bridge system 240 is developed for wireless frequency (RF) connection and network scalability when multi-hop communication has to be performed because an RF is not permanent or a single personal area network (PAN) extends over a physically large range.

The network management server 230 basically functions in the same manner as in FIG. 1, but deployment information may be registered using a menu of the network management server 230 and the sensor nodes 210 may collect and report position information. In a ZigBee-based wireless communication network, adjacent equipments spaced apart by 30 m or less can communicate data at a maximum speed of 250 Kbps. In the same PAN, the network management server 230 collects information and performs network management by means of wireless data communication by using the same wireless channel.

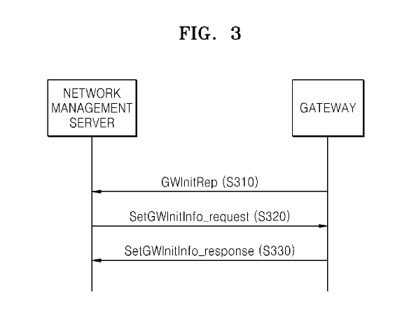

FIG. 3 is a ladder diagram illustrating a process of initializing a gateway according to an embodiment of the present invention.

Referring to FIG. 3, upon power-on, the gateway initializes resources such as a driver, a process, and a table and sends a gateway initialization report message GWInitRep to a network management server in operation S310. Upon receipt of the gateway initialization report message GWInitRep, the network management server sends a gateway information setup request message SetGWInitInfo_request to the gateway in order to set up an IP address and information required for network configuring such as a gateway identification (GW ID), channel information, and beacon capability and store the set IP address and information in a table in operation S320. The beacon capability may include a maximum depth, the maximum number of routers, the maximum number of child nodes, the beacon order (BO), the superframe order (SO), and topology information. The gateway then sends a response message SetGWInitInfo_response with respect to the gateway information setup request message SetGWInitInfo_request to the network management server in operation S330.

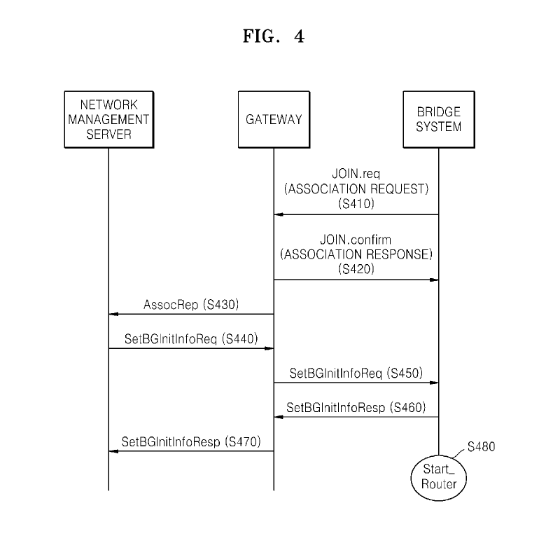

FIG. 4 is a ladder diagram illustrating a process of initializing a bridge system according to an embodiment of the present invention.

Referring to FIG. 4, upon power-on, the bridge system initializes a driver, a process, and a table and performs network exploration for association. By using network exploration, the bridge system searches for a gateway which is to be associated. If the gateway to be associated is found, the bridge system requests the found gateway to be associated with the bridge system by sending a join request JOIN.req to the gateway in operation S410. Upon receipt of the join request JOIN.req, the gateway allocates an address to the bridge system and accepts the joining of the bridge system. Upon receipt of an association response JOIN.confirm, the bridge system recognizes that association has been completed in operation S420. The gateway, which accepts the joining of the bridge system, sends an association report message AssocRep to a network management server in operation S430. If a node sending the association report message AssocRep is a bridge system, the network management server having received the association report message AssocRep sends a bridge information setup request message SetBGInitInfoReq including information about the bridge system to the gateway in operation S440. Upon receipt of the bridge information setup request message SetBGInitInfoReq, the gateway sends a bridge information setup request message SetBGInitInfoReq to the bridge system in operation S450. Upon receipt of the bridge information setup request message SetBGInitInfoReq, the bridge system stores bridge setup information in the table and sends a response message SetBGInitInfoResp with respect to the bridge information setup request message SetBGInitInfoReq to the gateway in operation S460. The gateway having sent the response message SetBGInitInfoResp also sends the response message SetBGInitInfoResp to the network management server in operation S470. After the bridge system then sends the response message SetBGInitInfoResp to the gateway in operation S460, it sends a start-router message Start_Router for configuring a network with sensor nodes through an RF and thus functions as a router in operation S480.

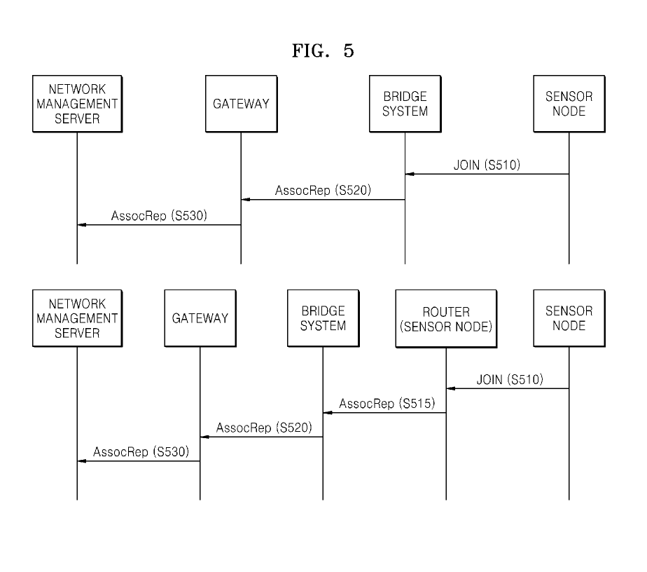

FIG. 5 is a ladder diagram illustrating a process of connecting a sensor node to a WSN according to an embodiment of the present invention.

Referring to FIG. 5, the sensor node searches for a bridge system (or a sensor node which functions as a router) by performing scanning for association with the bridge system (or a router) and then sends a join request message JOIN to the bridge system (or the router) in operation S510. Upon receipt of the join request message JOIN, the bridge system (or the router) accepts the joining of the sensor node by means of address allocation and sends a response message to the join request message JOIN to the sensor node. If association for the sensor node has been completed, the bridge system sends an association report message AssocRep to its upper system, i.e., a gateway in operation S520. In the case of the router, the router sends the association report message AssocRep to its upper system, i.e., a bridge system, in operation S515 and the bridge system having received the association report message AssocRep from its lower level delivers the received association report message AssocRep to its upper level, i.e., a gateway, in operation S520. Like the bridge system, the gateway having received the association report message AssocRep from the bridge system also sends an association report message AssocRep to a network management server in operation S530 for sensor network configuration management.

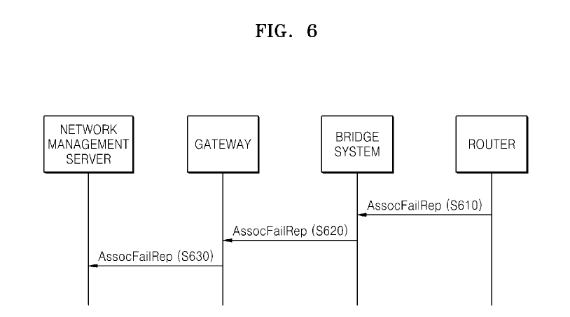

FIG. 6 is a ladder diagram illustrating a process of reporting an association failure according to an embodiment of the present invention.

Referring to FIG. 6, in a sensor node configuring process, if dense sensor nodes are deployed in a building or a house for the purpose of sensing information collection and servicing, association may not be properly performed due to interference from a radio signal and data transmission may not be performed smoothly. In this case, a desired service may not be provided and a network configuration may be changed occasionally, increasing power consumption of a sensor node which has to operate with low power consumption. Thus, in a sensor network, if a bridge system (or a router) fails to accept the joining of the sensor node for some reasons such as lack of provided address data and interference from a wireless channel according to an environment, an association failure report message AssocFailRep is sent up to a network management server in operations S610 through S630. Upon receipt of the association failure report message AssocFailRep, the network management server searches for another bridge system located in the same layer or in the same region as the router and the bridge system by using deployment information managed by the network management server and requests a wireless channel change. At this time, it is preferable that the network management server request a wireless channel change for a bridge system having the smallest number of associated nodes.

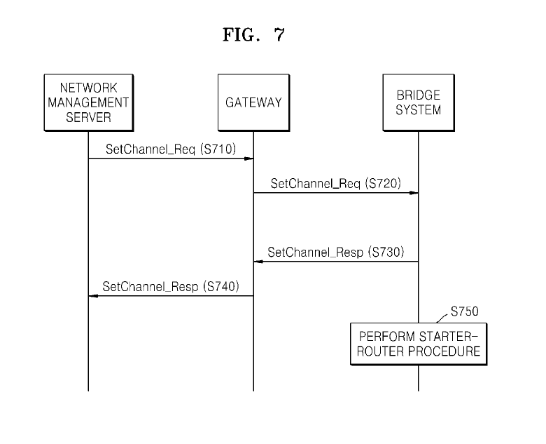

FIG. 7 is a ladder diagram illustrating a process of requesting a wireless channel change according to an embodiment of the present invention.

Referring to FIG. 7, in order to change a wireless channel of a bridge system, a network management server sends a channel change request message SetChannel_Req to a gateway in operation S710. Upon receipt of the channel change request message SetChannel_Req, the gateway stores channel information about a new channel to be used and then sends the channel change request message SetChannel_Req to the bridge system in operation S720. Upon receipt of the channel change request message SetChannel_Req, the bridge system stores the channel information about new channel and then sends a response message SetChannel_Resp with respect to the channel change request message SetChannel_Req to the gateway in operation S730. The bridge system erases information about all nodes connected with the bridge system because the information about all the nodes connected through a previous channel is useless due to a change of the previous channel into the new channel. Upon receipt of the response message SetChannel_Resp, the gateway sends the response message SetChannel_Resp to the network management server in operation S740. Like the bridge system, the gateway also erases the information about all the nodes connected with the bridge system. Upon receipt of the response message SetChannel_Resp from the gateway, the network management server recognizes that the wireless channel change has been completed, adjusts channel information for the bridge system to the new channel, and erases the information about all the nodes connected with the bridge system. After the wireless channel change is completed, the bridge system whose channel is changed performs a starter-router procedure for functioning as a router and configures a sensor network by using the new channel in operation S750.

As described above, according to the present invention, if wireless channel interference occurs frequently due to a dense-node environment, network instability resulting from channel interference can be overcome by maintaining different wireless channels for different bridge systems in the same PAN, thereby improving the stability and capacity of a sensor network. Moreover, since the stability of the sensor network is secured, frequent association requests originated from network instability and repetitive data transmissions caused by data transmission failures can be solved, thereby reducing power consumption and thus reducing the maintenance cost of the sensor network.

The use of different wireless channels for different bridge systems may be applied such that bridge systems in the same area or in the same floor (or adjacent floors) of the same building use different wireless channels by using deployment information during initialization of the bridge systems. In this case, the sensor node can be efficiently managed in a dense-node environment by applying a system operation policy without performing the processes illustrated in FIGS. 6 and 7.

While the present invention has been particularly shown and described with reference to an embodiment thereof, it will be understood by those of ordinary skill in the art that various changes in form and detail may be made therein without departing from the spirit and scope of the present invention as defined by the following claims.

What is claimed is:

1. A network management server of a wireless sensor network (WSN), the network management server comprising:
a communication unit communicating with bridge systems connected with a plurality of radio frequency (RF) regions within a personal area network (PAN) composed of sensor nodes using the same wireless channel, in which radio signals of the sensor nodes within the PAN reach the bridge systems;
a search unit searching for a new channel to be used and an alternative bridge system which is to perform a channel change into the new channel based on information about the bridge systems upon receipt of an association failure report message from an error bridge system which is reported of an association failure from the RF region from among the bridge systems;
a channel change requesting unit sending a channel change request message to the found alternative bridge system; and
an information management unit adjusting channel information for the found alternative bridge system to the new channel and replacing information about sensor nodes connected to the found alternative bridge system with information about sensor nodes that are newly connected with the found alternative bridge system through the new channel.

2. The network management server of claim 1, further comprising a gateway information requesting unit sending a message requesting information required for network configuring to a gateway upon receipt of a message indicating that the gateway has been initialized from the gateway,
wherein upon receipt of a gateway information setup request response message with respect to the message requesting the information from the gateway, the information management unit sets up network configuration information by using network configuration information included in the received gateway information setup request response message, and
the channel change requesting unit sends the channel change request message to the found alternative bridge system through the gateway.

3. The network management server of claim 1, further comprising a bridge information requesting unit sending a message requesting information required for network configuring to an initialized bridge system upon receipt of a bridge system initialization message from the initialized bridge system from among the bridge systems,
wherein upon receipt of a bridge information setup request response message with respect to the message requesting the information from the initialized bridge system, the information management unit sets up network configuration information by using network configuration information included in the received bridge information setup request response message, and
the search unit searches for the alternative bridge system based on the network configuration information.

4. A bridge system of a wireless sensor network (WSN), the bridge system comprising:
a communication unit communicating with a radio frequency (RF) region within a personal area network (PAN) composed of sensor nodes using the same wireless channel, by using a particular channel; and
an information management unit, upon receipt of a message requesting a change into a channel that is different form the particular channel from a network management server, registering information about the different channel and replacing information about sensor nodes connected through the particular channel with information about sensor nodes connected through the different channel,
wherein the communication unit communicates with the sensor nodes connected through the different channel by using the different channel if the information about the different channel is registered.

5. The bridge system of claim 4, further comprising:
a gateway search unit searching for a gateway to be associated; and
an association requesting unit sending a message requesting association with the founded gateway,
wherein upon receipt of a message indicating that the association has been completed from the gateway, the communication unit communicates with the RF region by using the particular channel.

6. A communication method at a network management server of a wireless sensor network (WSN), the communication method comprising:
communicating with bridge systems connected with a plurality of radio frequency (RF) regions within a personal area network (PAN) composed of sensor nodes using the same wireless channel, in which radio signals of the sensor nodes within the PAN reach the bridge systems;
searching for a new channel to be used and an alternative bridge system which is to perform a channel change into the new channel based on information about the bridge systems upon receipt of an association failure report message from an error bridge system which is reported of an association failure from the RF region from among the bridge systems;
sending a channel change request message to the found alternative bridge system; and
adjusting channel information for the found alternative bridge system to the new channel and replacing information about sensor nodes connected to the found alternative bridge system with information about sensor nodes that are newly connected with the found alternative bridge system through the new channel.

7. The communication method of claim 6, further comprising sending a message requesting information required for network configuring to a gateway upon receipt of a message indicating that the gateway has been initialized from the gateway,
wherein the registration of the information comprises, upon receiving a gateway information setup request response message with respect to the message requesting the information from the gateway, setting up network configuration information by using network configuration information included in the received gateway information setup request response message, and
the sending of the message comprises sending the channel change request message to the found alternative bridge system through the gateway.

8. The communication method of claim 6, further comprising sending a message requesting information required for network configuring to an initialized bridge system upon receipt of a bridge system initialization message from the initialized bridge system from among the bridge systems,
wherein the registration of the message comprises, upon receiving a bridge information setup request response message with respect to the message requesting the information from the initialized bridge system, setting up network configuration information by using network configuration information included in the received bridge information setup request response message, and
the searching comprises searching for the alternative bridge system based on the network configuration information.

9. A communication method at a bridge system of a wireless sensor network (WSN), the communication method comprising:
communicating with a radio frequency (RF) region within a personal area network (PAN) composed of sensor nodes using the same wireless channel, by using a particular channel; and
upon receiving a message requesting a change into a channel that is different form the particular channel from a network management server, registering information about the different channel and replacing information about sensor nodes connected through the particular channel with information about sensor nodes connected through the different channel,
wherein the communication comprises communicating with the sensor nodes connected through the different channel by using the different channel if the information about the different channel is registered.

10. The communication method of claim 9, further comprises:
searching for a gateway to be associated; and
sending a message requesting association with the founded gateway,
wherein the communication comprises, upon receiving a message indicating that the association has been completed from the gateway, communicating with the RF region by using the particular channel.
